(19) United States
(12) Patent Application Publication
(10) Pub. No.: US 2025/0270854 A1
(43) Pub. Date: Aug. 28, 2025

(54) EXIT DEVICE WITH LOCKDOWN FUNCTION

(71) Applicant: Sargent Manufacturing Company, New Haven, CT (US)

(72) Inventors: Richard D. Sangster, JR., Madison, CT (US); Jason Lynch, Orange, CT (US)

(73) Assignee: Sargent Manufacturing Company, New Haven, CT (US)

(21) Appl. No.: 19/037,687

(22) Filed: Jan. 27, 2025

Related U.S. Application Data
(60) Provisional application No. 63/557,363, filed on Feb. 23, 2024.

(51) Int. Cl. E05B 65/10; E05B 41/00; E05B 47/00

(52) U.S. Cl. CPC E05B 65/1053; E05B 41/00; E05B 47/0012; E05B 65/108; E05B 2047/0017

(57) ABSTRACT

Exit devices with lockdown functionality are disclosed. The exit device may include an indicator configured to indicate a state of the exit device, such as a lockdown state or a non-lockdown state. In the lockdown state, a push bar of the exit device may be prevented from moving. The exit device can include a latch movable between a latch retracted position and a latch extended position. Preventing movement of the push bar may prevent movement of the latch.

### RELATED APPLICATION

This Application is a Non-Provisional Application of U.S. Application Ser. No. 63/557,363, filed Feb. 23, 2024, entitled “EXIT DEVICE WITH LOCKDOWN FUNCTION”.

### FIELD

Disclosed embodiments are related to lockdown exit devices.

### BACKGROUND

Exit devices often include actuators such as push bars which a user may actuate to open a door. The actuators can be used to operate a latch. In some cases, the actuators may be maintained in a position. An indicator may be used to indicate a state of the exit device.

### SUMMARY

In some embodiments, an exit device comprises: a latch movable between an extended latch position and a retracted latch position; a push bar movable between a first push bar position and a second push bar position, wherein movement of the push bar from the first push bar position to the second push bar position moves the latch from the extended latch position to the retracted latch position; and a lockdown assembly configured to transition between a non-lockdown configuration and a lockdown configuration, wherein in the lockdown configuration the lockdown assembly is configured to maintain the push bar in the first push bar position.

In some embodiments, an exit device comprises: a latch movable between an extended latch position and a retracted latch position; a push bar movable between a first push bar position and a second push bar position, wherein movement of the push bar from the first push bar position to the second push bar position moves the latch from the extended latch position to the retracted latch position; a lockdown assembly configured to transition between a non-lockdown configuration and a lockdown configuration, wherein in the lockdown configuration the lockdown assembly is configured to maintain the push bar in the first push bar position; and an indicator configured to indicate the exit device is in a lockdown configuration in response to the lockdown assembly transitioning to the lockdown configuration.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A shows a schematic view of an exit device configured to be coupled to a door including multiple rods according to some embodiments;

FIG. 1B shows a schematic view of an exit device configured to be coupled to a door including one rod according to some embodiments;

FIG. 2 shows a schematic view of an exit device configured to be coupled to a door including a latch assembly according to some embodiments;

FIG. 3 shows a perspective view of an exit device according to some embodiments;

FIG. 4A shows a perspective view of an exit device with an indicator providing a first indication according to some embodiments;

FIG. 4B shows a perspective view of the exit device with the indicator providing a second indication according to some embodiments;

FIG. 5A shows a perspective view of an exit device in a lockdown configuration without a chassis according to some embodiments;

FIG. 5B shows a perspective view of the exit device in a non-lockdown configuration without the chassis according to some embodiments;

FIG. 6A shows a side view of the exit device in the lockdown configuration according to some embodiments;

FIG. 6B shows a side view of the exit device in the non-lockdown configuration according to some embodiments;

FIG. 7A shows a perspective view of a first portion of the exit device in the lockdown configuration according to some embodiments;

FIG. 7B shows a perspective view of the first portion of the exit device in the non-lockdown configuration according to some embodiments;

FIG. 8A shows a perspective view of a second portion of the exit device in the lockdown configuration according to some embodiments;

FIG. 8B shows a perspective view of the second portion of the exit device in the non-lockdown configuration according to some embodiments;

FIG. 8C shows a perspective view of the second portion of the exit device in the non-lockdown configuration including an actuator bracket according to some embodiments;

FIG. 9A shows a perspective view of an exit device in the lockdown configuration including an indicator according to some embodiments;

FIG. 9B shows a perspective view of the exit device in the lockdown configuration including the indicator in the first state without an indicator housing according to some embodiments;

FIG. 10A shows a perspective view of the exit device including the indicator in the non-lockdown configuration according to some embodiments;

FIG. 10B shows a perspective view of the exit device including the indicator in the non-lockdown configuration without an indicator housing according to some embodiments;

FIG. 11 shows a perspective view of an indicator lever arm according to some embodiments;

FIG. 12A shows a perspective view of a drive component according to some embodiments;

FIG. 12B shows another perspective view of the drive component according to some embodiments;

FIG. 13A shows a perspective view of a lift arm according to some embodiments; and

FIG. 13B shows another perspective view of the lift arm according to some embodiments.

### DETAILED DESCRIPTION

Doors are often used to selectively restrict access to a space, such as an interior of a room or building. Doors often include exit devices that selectively lock and unlock the door to selectively restrict access to the space. The exit devices can include an indicator configured to indicate whether the door is locked or unlocked. Some exit devices can be transitioned from a non-lockdown state to a lockdown state. The inventors have identified a need for an exit device which may be quickly transitioned to a lockdown state. Examples of environments where an exit device that is quickly transitioned to a lockdown state may be beneficial include classrooms, bathrooms, offices, meeting rooms, and any other suitable room or space where privacy, shelter, or restricted access are desired. This may be useful in instances where restricting access to the interior of a room is desired. In such instances, a latch actuator such as a door knob or handle on an exterior side of the door is disabled, thereby preventing operation of the exit device on the exterior side while allowing operation of the exit device using an interior latch actuator such as a push bar disposed on an interior side of the door. This may serve to prevent to prevent intruders or other persons intended from entering the interior of the room. As such, the inventors have recognized an exit device that may be quickly transitioned to a lockdown state. The exit device may provide other benefits such as remote operation of the exit device and/or quickly providing an indication of the state of the exit device.

An exit device may include a latch movable between an extended latch position and a retracted latch position. The exit device may also include a push bar movable between a first push bar position and a second push bar position. Movement of the push bar from the first push bar position to the second push bar position may move the latch from the extended latch position to the retracted latch position. The exit device may include a lockdown actuator. The lockdown actuator may be actuated to transition the lockdown assembly between a non-lockdown configuration and a lockdown configuration. In the lockdown configuration, the lockdown assembly may be configured to maintain the push bar in the first push bar position. In some cases, the lockdown assembly is configured to move the push bar to the first push bar position and maintain the push bar in first push bar position.

In some cases, the exit device includes a lockdown interface such as a rotatable lock cylinder. The lock cylinder is rotatable using a key in some embodiments. In some cases, the lock cylinder is rotatable via a thumb turn or knob. Rotating the lock cylinder may transition the lockdown assembly between the non-lockdown configuration and the lockdown configuration. For example, in response to rotation of the lock cylinder, the lockdown actuator may be configured to transition the lockdown assembly between the non-lockdown configuration and the lockdown configuration. The lockdown actuator may be formed as a motor, linear actuator, or any other appropriate mechanical or electromechanical actuator.

In some embodiments, the lockdown actuator may be operatively coupled to a lift arm and may be configured to move the lift arm between a first lift arm position and a second lift arm position. The lift arm may be movably coupled to the push bar. As such, the lockdown actuator may be configured to move the push bar via the lift arm. For example, the lockdown actuator may be controlled to move and/or maintain the push bar in the first push bar position, thereby preventing operation of the push bar and restricting access to an associated door and space. In some cases one or more components may be used to couple movement of the lockdown actuator to the lift arm. For example, the lockdown actuator may be coupled to the lift arm via a primary connecting member. In some embodiments, the primary connecting member is movably coupled to a secondary connecting member, and the secondary connecting member is movably coupled to the lift arm. In further embodiments, the secondary connecting member is movably coupled to a tertiary connecting member, and the tertiary connecting member is movably coupled to the lift arm. Any appropriate movable component of the exit device may be biased in a direction using one or more biasing elements. For example, the primary connecting member may be movable between a first primary connecting member position and a second primary connecting member position and may be biased towards the first primary connecting member position using a primary connecting member biasing element. In another example, the push bar may be biased to the first push bar position using one or more push bar biasing elements.

In some embodiments, the exit device includes an indicator configured to indicate a state of the exit device. For example, the indicator may be configured to indicate whether the lockdown assembly is in the non-lockdown configuration or the lockdown configuration. The indicator can include one or more indicator faces configured to provide an indication indicative of the state of the exit device. In some embodiments, the indicator face is visible through an indicator window. Optionally, one or more portions of the indicator or exit device are illuminated using a light source to provide an indication of the state of the exit device. In some cases, the lockdown assembly is able to be controlled remotely. The lockdown assembly may also be operated based on a predetermined schedule. For example, during a first period of time (e.g., business hours) the lockdown assembly may be configured to be in the non-lockdown configuration and during a second period of time the lockdown assembly may be configured to be in the lockdown configuration. In some cases, the exit device is operable using an access card (e.g., key card). In such cases, the override assembly may optionally not be operable via the access card. In some embodiments, the lockdown assembly is operable via both sides of an associated door. In some cases, the lockdown assembly is operable via a single side (e.g., the interior side) of the associated door, which may include the push bar.

The indicator may include an indicator body movable between a first indicator body position and a second indicator body position. In some cases, the indicator is configured to indicate that the exit device is in a lockdown state while the indicator body is in the first indicator body position and indicate that the exit device is in a non-lockdown state while the indicator body is in the second indicator body position. The indicator may include one or more indicator faces, which may be configured to provide the indication indicative of the state of the exit device. For example, the indicator may include a first indicator face configured to indicate the exit device is in a lockdown state and a second indicator face configured to indicate the exit device is in a non-lockdown state. In embodiments including an indicator window, one of the first indicator face and the second indicator face may be visible through the indicator window. In some cases, the indicator includes an indicator body biasing element configured to bias and/or apply a force to the indicator body.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

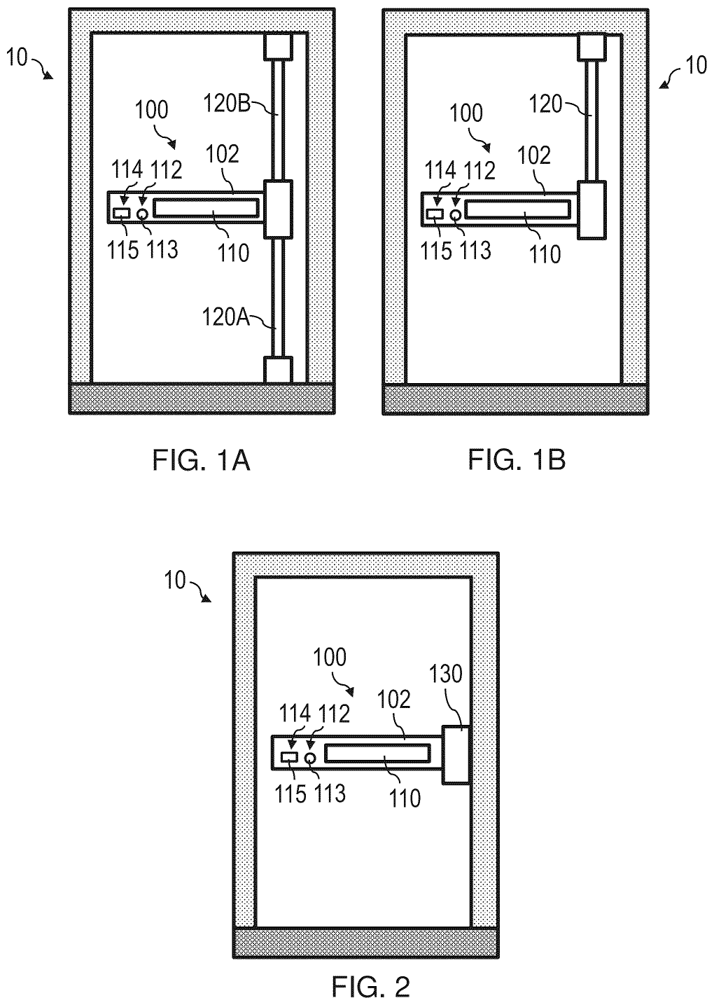

As discussed herein, the exit device is configured to be coupled to a door according to some embodiments. For example, the exit device is shown coupled to a door in the depicted embodiments of FIGS. 1-2. More specifically, a door system 10 includes an exit device 100 having a push bar 110. In the depicted embodiments of FIGS. 1A and 1B, the exit device 100 also includes one or more rods 120 for securing the door. The rod 120 may be operatively coupled to a latch and/or latch assembly, which may be used to secure the door. For example, the push bar 110 may be actuated, and the rod 120 may move a latch or latch assembly to secure the door. Depending on the embodiment, a single rod or multiple rods are used. For example, in the depicted embodiment of FIG. 1A, the exit device 100 includes two rods 120A, 120B. In the depicted embodiment of FIG. 1A, the rods 120A, and 120B are configured to secure the door on both of an upper and lower portion of a door frame. In another example, such as the depicted embodiment of FIG. 1B, the exit device 100 includes a single rod 120 configured to secure the door on an upper portion of a door frame. In the depicted embodiment of FIG. 2, the exit device includes a latch assembly 130 configured to secure the door on a side portion of the door frame. The latch assembly may include a door latch (e.g., latch or bolt) configured to secure the door via the side portion of the door frame. The exit device 100 may also include a lockdown assembly 112 having a lockdown interface 113 and an indicator 114 having an indicator window 115, as described herein and further below. In the depicted embodiments of FIGS. 1-2, the lockdown interface 113 and indicator window 115 are disposed on a face of a chassis 102 of the exit device 100. It should be understood that the exit device 100 may optionally be formed with the indicator 114. Accordingly, the embodiments described herein, including the depicted embodiments of FIGS. 1A, 1B, and 2 may be formed without the indicator 114. It should be appreciated that the indicator 114, indicator window 115, lockdown assembly 112, and lockdown interface 113 may be positioned on any appropriate portion of the chassis 102 or other portion of the exit device 100 as the disclosure is not limited in this sense.

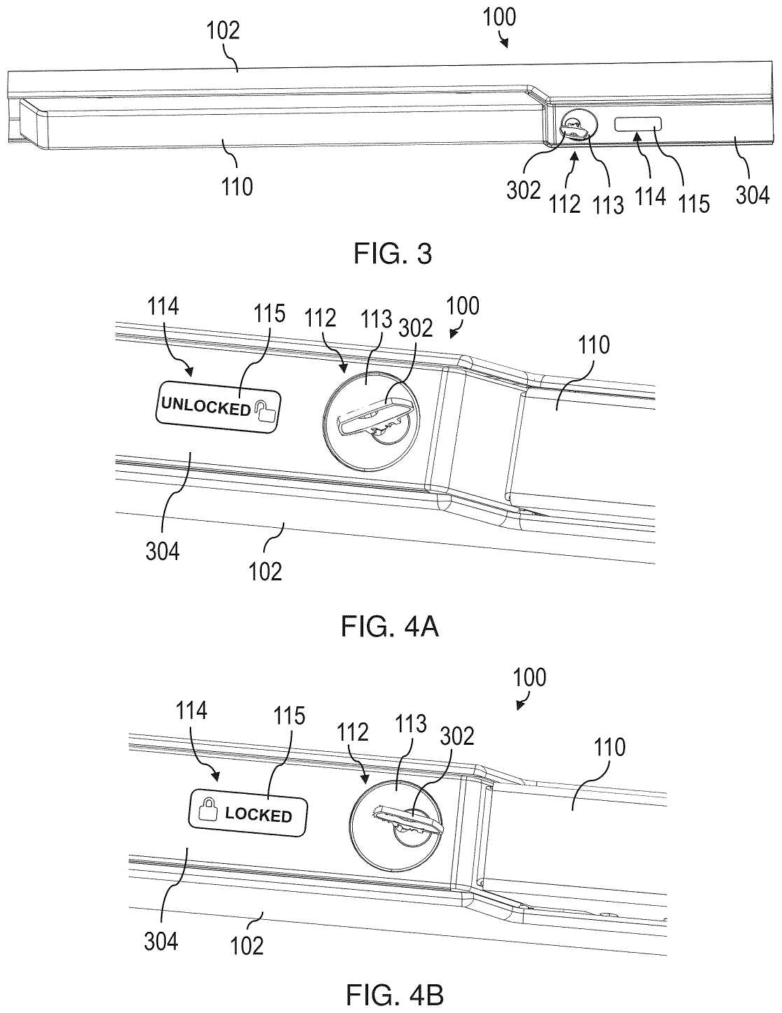

FIG. 3 shows a perspective view of the exit device 100 according to some embodiments. The chassis 102 may include a front chassis phase 304. In the depicted embodiment of FIG. 3, the lockdown interface 113 and the indicator window 115 are formed in the front chassis plate 304. The depicted embodiment of FIG. 3 also shows a key 302 engaged with the lockdown interface 113. FIGS. 4A and 4B show perspective views of the exit device 100 in a non-lockdown state, and a lockdown state, respectively. In the depicted embodiment of FIG. 4A, the exit device 100 is in a non-lockdown state, and the indicator 114 provides an indication indicative of the exit device 100 being in the non-lockdown state. Specifically, an indicator face indicative of the non-lockdown configuration is visible through the indicator window 115. In the depicted embodiment of FIG. 4A, the push bar 110 is shown in the second push bar position. In the depicted embodiment of FIG. 4B, the exit device 100 is in the lockdown state, and the indicator 114 provides an indication indicative of the exit device 500 being in the lockdown state. Specifically, in indicator face indicative of the exit device 100 being in the lockdown state is visible through the indicator window 115. In the depicted embodiment of FIG. 4B, the push bar 110 is shown in the first push bar position. As previously described, the push bar 110 may be maintained in the first push bar position while the exit device 100 is in the lockdown configuration.

While embodiments of the indicator faces are depicted in the figures, it should be appreciated that the indicator face may include any appropriate text, logos, icons, shapes, colors, numbers, or other visual indications as the disclosure is not limited in this sense. In some cases, the indicator face configured to indicate the non-lockdown configuration may be formed to be blank (e.g., not containing any markings) to be non-descript, and the indicator face configured to indicate the lockdown configuration may be formed to include markings or other indications to more easily indicate to the user that the exit device is in the lockdown configuration.

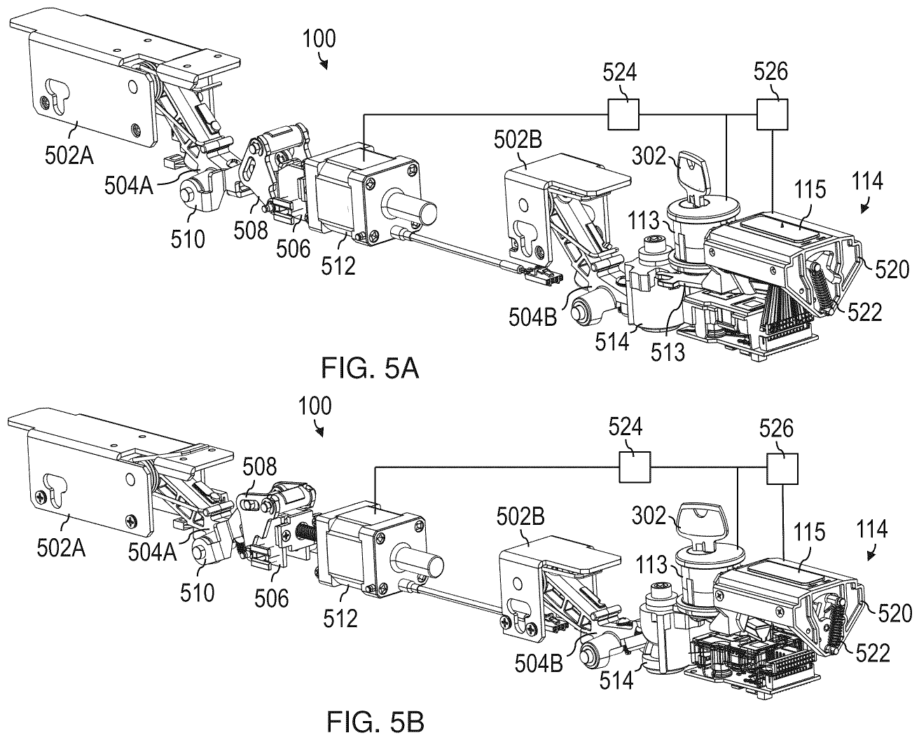

The depicted embodiments of FIGS. 5A and 5B show perspective views of the exit device 100 in the lockdown configuration and the non-lockdown configuration, respectively. The exit device 100 may include one or more lift members 502. For example, the depicted embodiments of FIGS. 5A and 5B include a first lift member 502A and a second lift member 502B. The lift member 502 may be coupled to the push bar 110 and may be configured to move in conjunction with the push bar 110. The lift member 502 may be movable between a first lift member position and a second lift member position. In embodiments where the push bar is configured to move in conjunction with the lift member 502, the push bar may move between the first push bar position and the second push bar position in conjunction with the lift member 502 moving between the first lift member position and the second lift member position. In the depicted embodiments of FIGS. 5A and 5B, the lift member 502 is formed as a bracket, however the lift member 502 may be formed in any appropriate geometry as the disclosure is not limited in this sense. Further, the exit device 100 may include any appropriate quantity of lift members is a disclosure is also not limited in this sense.

The lift member 502 may be movably coupled to the lift arm 504. The lift arm 504 may be movable between a first lift arm position and a second lift arm position. In some cases, the lift arm 504 may be directly and movably coupled to the push bar 110. The exit device 100 may include any appropriate quantity of lift arms 504, for example, in the depicted embodiment of FIGS. 5A and 5B, the exit device 100 includes a first lift arm 504A and a second lift arm 504B. In some cases, the lift arm 502 is configured to rotate between the first lift arm position and the second lift arm position. Movement of the lift arm from the first lift arm position to the second lift arm position may move the lift member 502 from the first lift member position to the second lift member position. Similarly, movement of the push bar 110 and or the lift member 502 from the first push bar position to the second push bar position and/or the lift member from the first lift member position to the second lift member position may move the lift arm 504 from the first lift arm position to the second lift arm position.

The first lift arm 504A may be operatively coupled to a lockdown actuator 512. For example, lockdown actuator 512 may be configured to move the lift arm 504A between the first lift arm position and the second lift arm position. In the depicted embodiments of FIGS. 5A and 5B, the lockdown actuator 512 is depicted as a motor. In some cases, the lockdown actuator 512 is configured to move the lift arm 504A to the first lift arm position in response to power being shut off to the lockdown actuator 512. As such, in response to power being shut off from the motor, the push bar 110 may move to the first push bar position and the latch may move to the extended latch position. Similarly, the lockdown actuator 512 may be configured to move the lift arm 504 from the first lift arm position to the second lift arm position in response to power being provided to the lockdown actuator 512. The lockdown actuator 512 may be operatively coupled to and controlled by a controller 524. The controller 524 may also be operatively coupled to the lockdown interface 113. In some cases, the controller 524 is configured to control the lockdown output actuator 512 in response to actuation of the lockdown interface 113.

In some embodiments, the lockdown actuator 512 is configured to move the lift arm 504 via one or more intervening components. For example, the exit device 100 may include a primary connecting member 506 movable between a first primary connecting member position and a second primary connecting member position. The lockdown actuator 512 may be configured to move the primary connecting member 506 between the first primary connecting member position and the second primary connecting member position. Exit device 100 may also include a secondary connecting member 508 configured to move between a first secondary connecting member position and a second secondary connecting member position. In some cases, the secondary connecting member 508 may be configured to rotate between the first secondary connecting member position and the second secondary connecting member position. The secondary connecting member 508 may be movably coupled to the primary connecting member 506, such that movement of the primary connecting member from the first primary connecting member position to the second primary connecting member position moves the secondary connecting member from the first secondary connecting member position to the second secondary connecting member position. Exit device 100 may also include a tertiary connecting member 510 movable between a first tertiary connecting member position and a second tertiary member connecting position. In some cases, the tertiary connecting member 510 is configured to rotate between the first tertiary connecting member position and the second tertiary connecting member position. In the depicted embodiments of FIGS. 5A and 5B, the primary connecting member 506 is movably coupled to the lockdown actuator 512 and the secondary connecting member 508. In the depicted embodiments of FIGS. 5A and 5B, the secondary connecting member 508 is movably coupled to the primary connecting member 506 and the tertiary connecting member 510. In the depicted embodiments of FIGS. 5A and 5B, the tertiary connecting member 510 is movably coupled to the secondary connecting member 508 and the first lift arm 504A.

The exit device 100 may also include the second lift arm 504B which may be movably coupled to the second lift member 502B. The second lift arm five of 4B may also be movably coupled to a drive component 514. The drive component may be configured to move between a first drive component position and a second drive component position. In some cases, the drive component rotates between the first drive component position and the second drive component position. The drive component may be configured to move from the first tried component position to the second drive component position in response to the lift arm 504B moving from the first lift arm position to the second arm position. It should be understood that movement of the push bar 110 (not shown in FIGS. 5A and 5B) from the first push bar position to the second push bar position may move the lift arms 504A, 504B and/or the lift members 502A, 502B, from their respective first lift arm positions to the second lift arm positions and/or first lift member positions to the second lift member positions.

The depicted embodiment of the exit device 100 in figs five a and 5B includes an indicator 114. The indicator 114 may include an indicator housing 520 configured to support components of the indicator 114. Indicator 114 may also include an indicator biasing element 522 configured to bias and/or apply a force to one or more portions of the indicator 114, discussed further with respect to proceeding figures. The exit device 100 may include an indicator lever arm 513 movably coupled to the drive component 514 and configured to move between a first indicator lever arm position and a second indicator lever arm position. In some cases, the indicator lever arm 513 is configured to rotate between the first indicator lever arm position and the second indicator lever arm position.

In the depicted embodiment of FIG. 5A, the lift members 502A, 502B are shown in the first lift member position, the lift arms 504A, 504B are shown in the first lift arm position, the primary connecting member 506 is shown in first primary connecting member position, the secondary connecting member 508 is shown in the first secondary connecting member position, the tertiary connecting member 510 is shown in the first tertiary connecting member position, the drive component 514 is shown in the first drive component position, and the indicator lever arm 513 is shown in the first indicator lever arm position.

In the depicted embodiment of FIG. 5B, the lift members 502A, 502B are shown in the second lift member position, the lift arms 504A, 504B are shown in the second lift arm position, the primary connecting member 506 is shown in second primary connecting member position, the secondary connecting member 508 is shown in the second secondary connecting member position, the tertiary connecting member 510 is shown in the second tertiary connecting member position, the drive component 514 is shown in the second drive component position, and the indicator lever arm 513 is shown in the second indicator lever arm position.

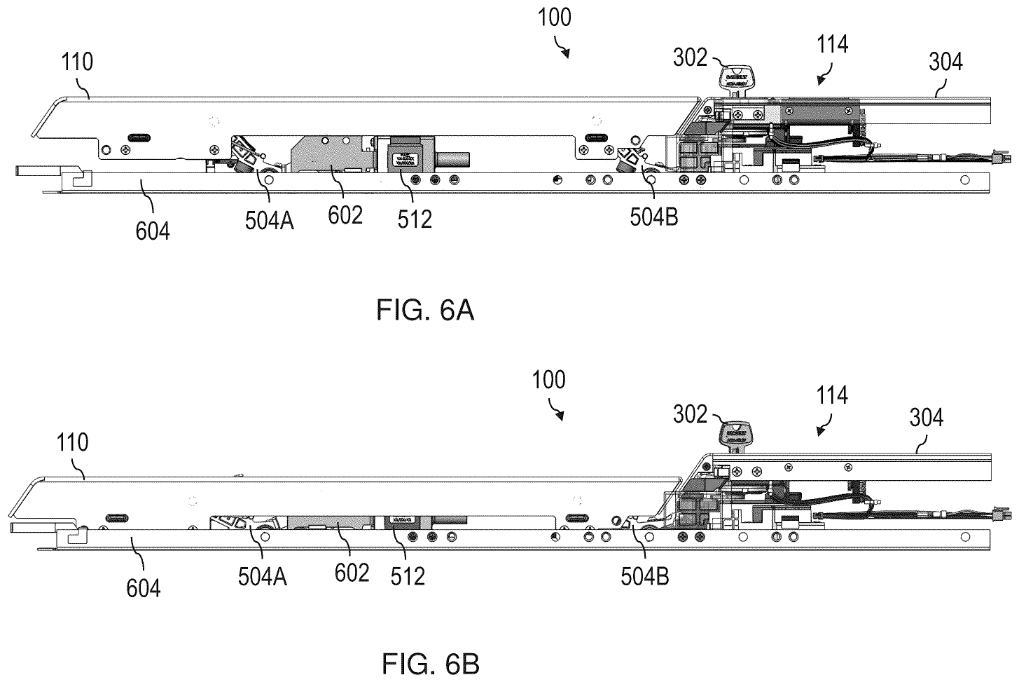

FIGS. 6A and 6B show side views the exit device 100 in a lockdown state and a non-lockdown state, respectively, according to some embodiments. In the depicted embodiment of FIG. 6A, the push bar 110 is shown in the first push bar position. The depicted embodiment of FIG. 6B, the push bar 110 is shown in the second push bar position. The exit device 100 may include an actuator bracket 602, which is described further with respect to proceeding figures. The exit device 100 may also include a bottom exit device housing 604, which may be configured to support one or more components of the exit device 100.

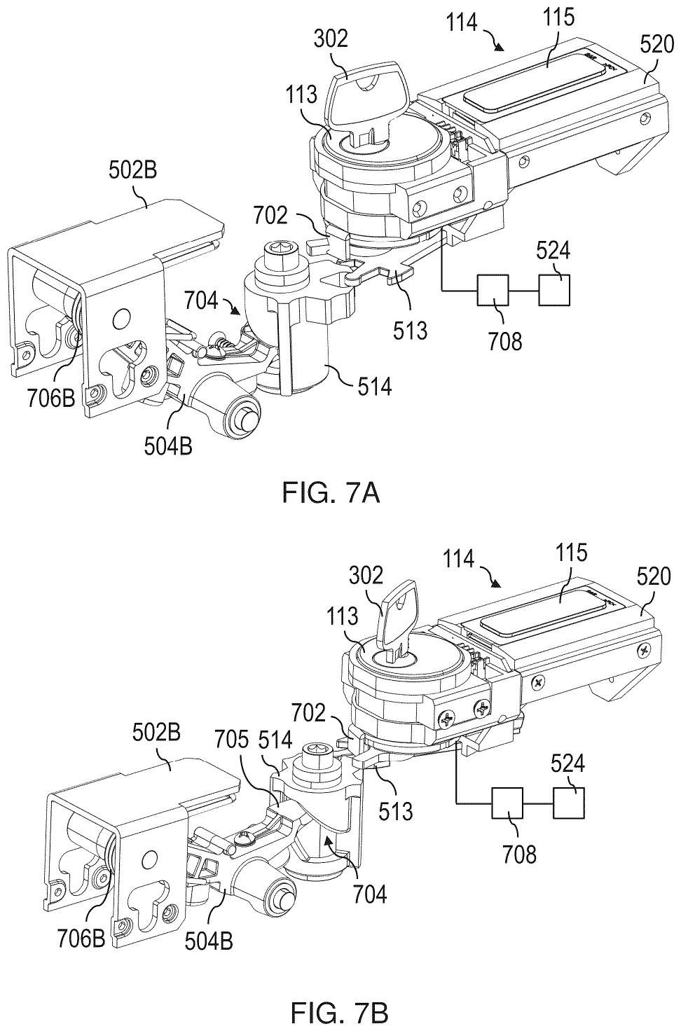

FIGS. 7A and 7B depict a portion of the exit device 100 in a lockdown state and a non-lockdown state, respectively. As previously discussed, the lockdown interface 113 may be used to transition the exit device 100 between the lockdown state and a non-lockdown state. In the depicted embodiments of FIGS. 7A and 7B, the lockdown interface 113 is formed as a lock cylinder configured to receive the key 302. A cam plate 702 may be movably coupled to the lockdown interface 113 and movable between a first cam plate position and a second cam plate position. For example, rotation of the lockdown interface 113 from a first lockdown interface position to a second lockdown interface position may rotate the cam plate 702 from the first cam plate position to the second cam plate position. The cam plate 702 may be configured to engage with a lockdown switch 708, and/or the lockdown switch 708 may be configured to detect a position and/or configuration of the cam plate 702 and/or lockdown interface 113. The lockdown switch 708 may be operatively coupled to the controller 524, and the controller 524 may be configured to obtain the detected position and/or configuration from the lockdown switch 708. In some cases, the cam plate 702 may be configured to contact and change the state of the lockdown switch 708 as the cam plate 702 moves.

As previously discussed, the lift arm 504 may be configured to engage the drive component 514. The drive component 514 may include a drive channel 704 configured to receive a lift arm projection 705 of the lift arm 704. The drive channel 704 may include one or more spiral/helical ramps, discussed further with respect to proceeding figures. Movement of the lift arm 504 from the first lift arm position to the second lift arm position may move the lift arm projection 705 within the drive channel 704, such that the lift arm projection 705 engages a surface of the drive channel 704 while the lift arm 504 moves, thereby moving the drive component 514 from the first drive component position to the second drive component position. Movement of the drive component 514 from the first drive component position to the second drive component position may cause one or more portions of the drive component 514 to engage one or more portions of the indicator lever arm 513, discussed further with respect to proceeding figures. For example, movement of the drive component 514 from the first drive component position to the second drive component position may move the indicator lever arm 513 from the first indicator lever arm position to the second indicator lever arm position. As will be discussed further with respect to proceeding figures, movement of the indicator lever arm 513 may move a portion of the indicator 114, thereby changing the indication provided by the indicator 114. The exit device 100 may include a lift arm biasing element 706B configured to bias the lift arm 504B and/or the lift member 502B, which optionally may be formed as a torsion spring. For example, the lift arm biasing element 706B may be configured to bias the lift arm 504B and/or the lift member 502B towards the first lift arm position and/or the first lift member position.

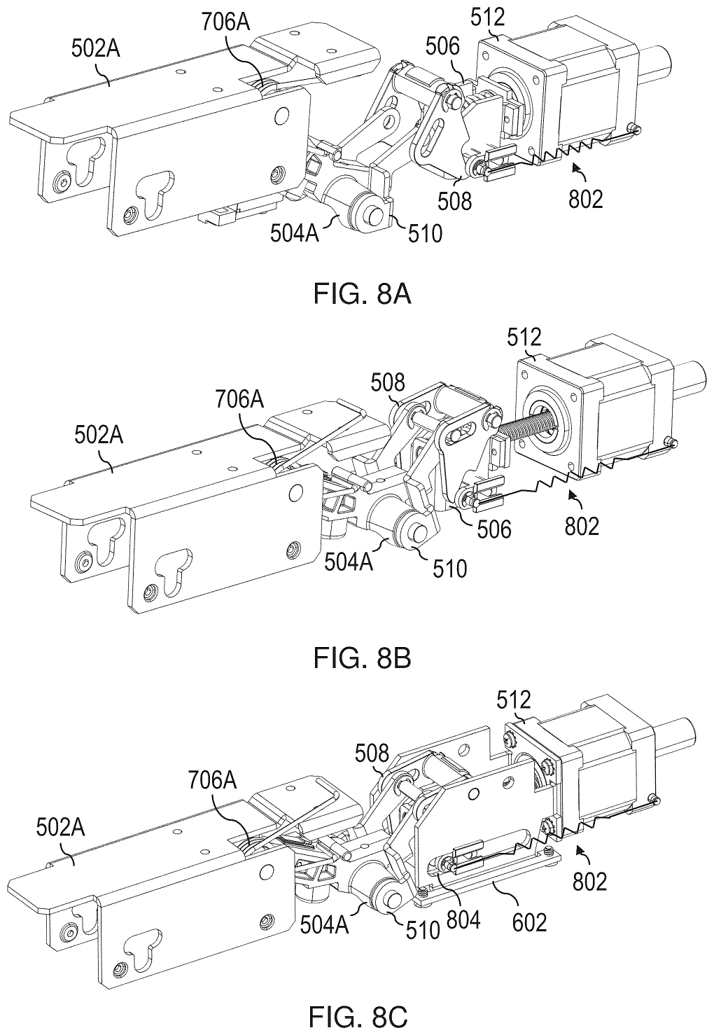

FIGS. 8A and 8B show another portion of the exit device 100 in a lockdown state and a non-lockdown state, respectively. FIG. 8C shows the portion of the exit device 100 including an actuator bracket 602 in the non-lockdown state. In some embodiments, the exit device 100 includes a connecting member biasing element 802 configured to bias one or more of the lockdown actuator 512, the first connecting member 506, the second connecting member 508, the tertiary connecting member 510, and the lift arm 504A in a direction. For example, in the depicted embodiments of FIGS. 8A, 8B, and 8C, the connecting member biasing element 802 is coupled to the lockdown actuator 512 and the primary connecting member 506 and is configured to bias the primary connecting member 506 to the first primary connecting member position. However, it should be appreciated that the connecting member biasing element 802 may be coupled to any appropriate components of the exit device 100 as the disclosure is not limited to the depicted embodiments.

In the depicted embodiments of FIGS. 8A, 8B, and 8C, the primary connecting member 506 is configured to move linearly between the first primary connecting member position and the second primary connecting member position. Optionally, the primary connecting member 506 may be slidingly coupled to the actuator bracket 602. For example, a portion of the primary connecting member 506 may be configured to slide within an actuator bracket slot 804 of the actuator bracket 602. In the depicted embodiments of FIGS. 8A, 8B, and 8C, the secondary connecting member 508 is configured to rotate between the first secondary connecting member position and the second secondary connecting member position. Also in the depicted embodiments, the secondary connecting member 508 includes a slot configured to receive a portion of the tertiary connecting member 510. It should be appreciated that each of the primary connecting member 506, the secondary connecting member 508, and the tertiary connecting member 510 may be formed in any appropriate geometry as the disclosure is not limited in this sense.

In the depicted embodiments of FIGS. 8A, 8B, and 8C, the lockdown actuator 512 is formed as a motor configured to selectively rotate a threaded shaft. The threaded shaft may be configured to move the first connecting member 506 linearly upon rotation. In some embodiments, the threaded shaft retracts into the motor upon power being shut off to the motor. In the depicted embodiments of FIGS. 8A, 8B, and 8C, the lift member 502A is biased to the first lift member position using a lift arm biasing member 706A.

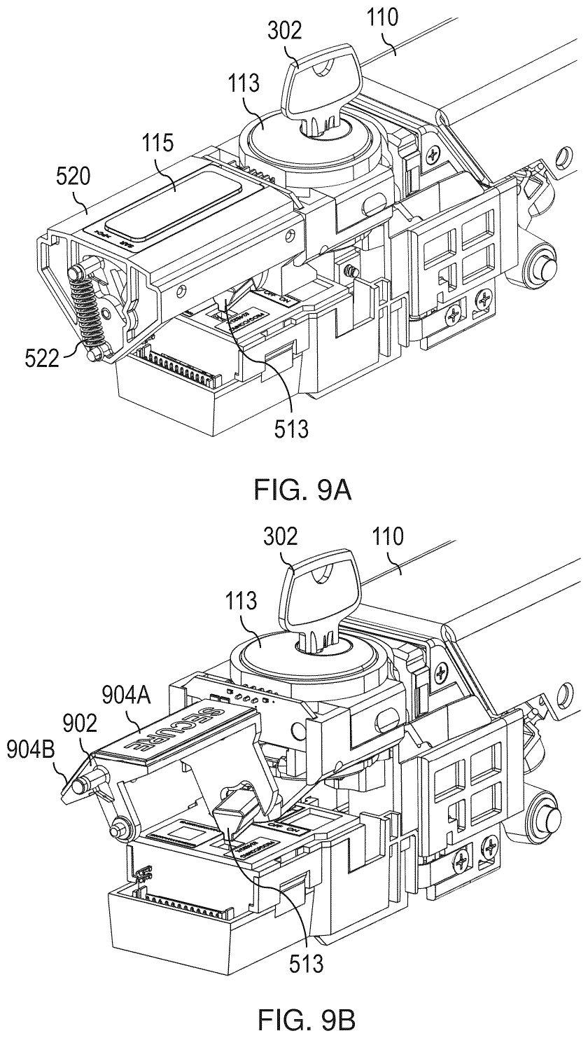

FIG. 9A shows a portion of the exit device 100 in the lockdown state according to some embodiments. FIG. 9B also shows the portion of the exit device 100 in the lockdown state, without the indicator housing 520 shown according to some embodiments. As best seen in the depicted embodiment of FIG. 9B, the indicator 114 may include an indicator body 902. The indicator body 902 may be movable between a first indicator body position and a second indicator body position. One or more indicator faces 904 may be coupled to and configured to move with the indicator body 902. For example, in the depicted embodiment of FIG. 9B, the indicator 114 includes two indicator faces 904A, 904B. The indicator face 904A may be associated with and configured to indicate the lockdown configuration. The indicator face 904B may be associated with him configured to indicate the non-lockdown configuration. The indicator body 902 may be configured to rotate between the first indicator body position and the second indicator by position. The indicator lever arm 513 may be configured to move the indicator body 902 between the first indicator body position and the second indicator body position. For example, movement of the indicator lever arm 513 from the first indicator lever arm position to the second indicator lever arm position may move the indicator body 902 from the first indicator body position to the second indicator body position. Similarly, movement of the indicator lever arm 513 from the second indicator lever arm position to the first indicator lever arm position may move the indicator body 902 from the second indicator body position to the first indicator body position. One or more portions of the indicator body 902, such as one or more projections of the indicator body may be configured to engage the indicator lever arm 513 to couple movement of the indicator lever arm 513 to the indicator body 902. In the depicted embodiments of FIGS. 9A and 9B the indicator body 902 is shown in the first indicator body position and the indicator lever arm 513 is shown in the first indicator lever arm position.

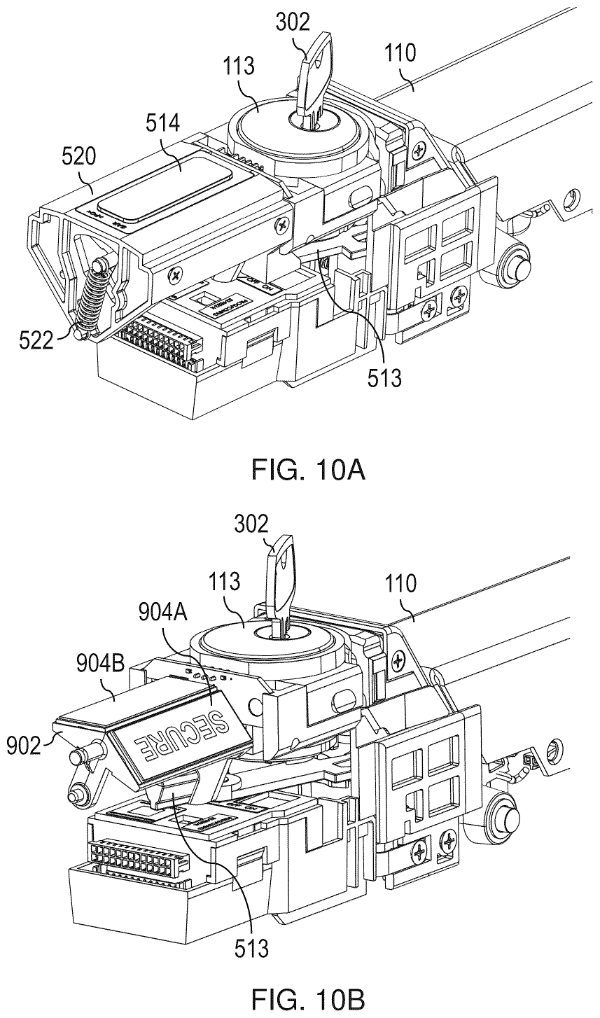

The depicted embodiments of FIGS. 10A and 10B show the same portion of the exit device as shown in FIGS. 9A and 9B, with the exit device in the non-lockdown configuration. In the depicted embodiments of FIGS. 10A and 10B, the indicator body 902 is shown in the second indicator body position in the indicator lever arm 513 shown in the second indicator lever arm position. As previously discussed, the indicator 114 may include an indicator biasing element 522. The indicator biasing element 522 may be coupled to one are more portions of the indicator body 902 and/or the indicator body 520. In some cases, the indicator biasing element 522 may be configured to maintain a tension in association with the indicator body 902 to assist in providing stable movement of the indicator body 902. In some cases, indicator biasing element 522 may be configured to bias the indicator body 902 to either the first indicator body position or the second indicator body position.

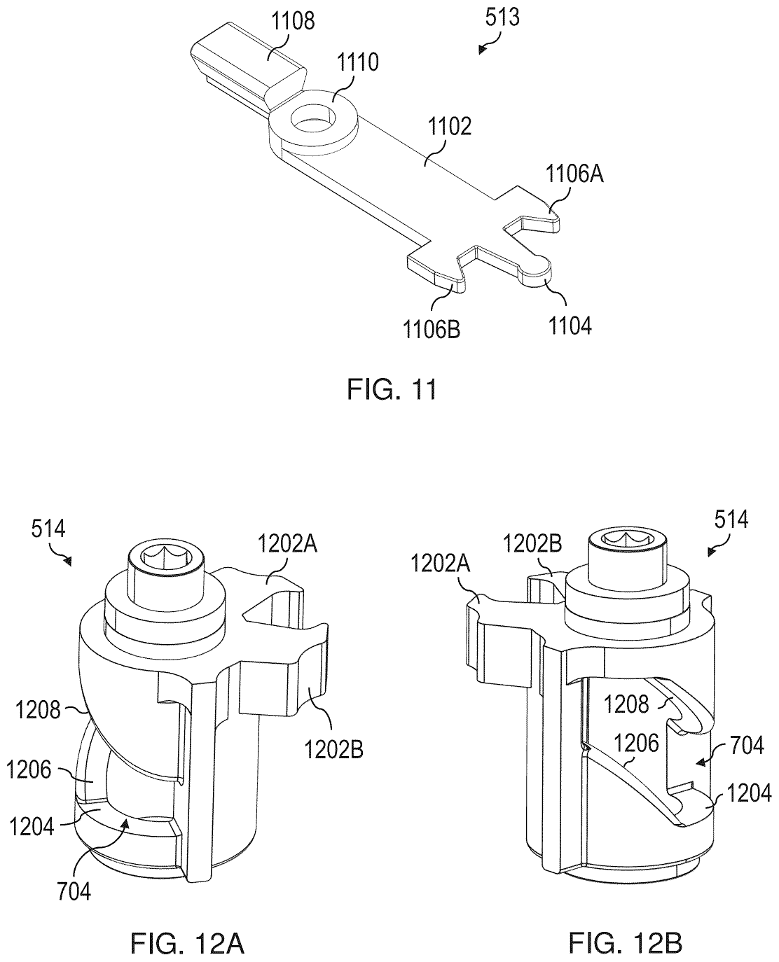

FIG. 11 shows a perspective view of the indicator lever arm 513 according to some embodiments. The indicator lever arm 513 may include an indicator lever body 1102 with indicator lever projection 1104 coupled thereto. One or more indicator lever prongs 1106A, 1106B may also be coupled to the indicator lever body 1102. The indicator lever prongs 1106A, 1106B may be formed proximate to the indicator lever projection 1104. In some cases, the indicator lever arm 513 may be configured to rotate about an indicator lever hub 1110, which is coupled to the indicator body 1102. The indicator lever arm 513 may also include an indicator lever tab 1108 which may be coupled to one or both of the indicator lever hub 1110 and the indicator lever body 1102. The indicator lever projection 1104 may be configured to engage one or more portions of the drive component 514. Optionally, the indicator lever prongs 1106A, 1106B may also be configured to engage one or more portions of the drive component 514. The indicator lever tab 1108 may be configured to engage the indicator body 902, as described herein. It should be understood that the indicator lever arm 513 may be formed in any appropriate geometry as the disclosure is not limited to the depicted embodiment of FIG. 11.

FIGS. 12A and 12B depict the drive component 514 according to some embodiments. The drive component 514 may include one or more portions configured to engage the indicator lever arm 513 as described herein. For example, the drive component 514 may include one or more drive tabs 1202A, 1202B configured to engage one or more of the indicator lever projection 1104 and the indicator lever prongs 1106A, 1106B. For example, rotation of the drive component 514 may cause one or both of the drive tabs 1202A, 1202B to engage the indicator lever projection 1104 to rotate the indicator lever arm 513.

The drive component 514 may include a drive channel 704 as previously discussed. The drive channel 704 may include a bottom drive surface 1204, a bottom drive ramp 1206, and a top drive ramp 1208. In some embodiments, the bottom drive ramp 1206 and the top drive ramp 1208 form a helical/spiral geometry. Also previously discussed, movement of the lift arm 504 may move the drive component 514. For example, the lift arm projection 705 may be configured to engage the bottom drive ramp 1206 and the top drive ramp 1208. Movement of the lift arm 504 between the first lift arm position and the second lift arm position may cause the lift arm projection 705 to engage the bottom drive ramp 1206 or the top drive ramp 1208, depending on the direction of movement of the lift arm 504. For example, movement of the lift arm 504 from the first lift arm position to the second lift arm position may cause the lift arm projection 705 to engage the top drive ramp 1208, causing the drive component 514 to rotate from the first drive component position to the second drive component position. Similarly, movement of the lift arm 504 from the second lift arm position to the first lift arm position may cause the lift arm projection 705 to engage the bottom drive ramp 1206, causing the drive component 514 to rotate from the second drive component position to the first drive component position.

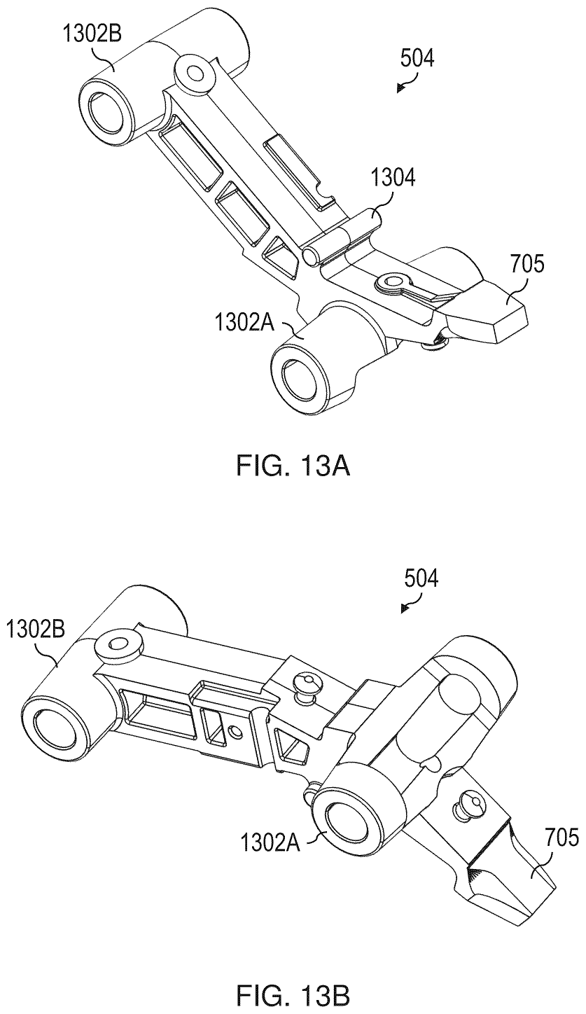

FIGS. 13A and 13B depict the lift arm 504 according to some embodiments. The lift arm 504 may include one or more lift arm hubs 1302A, 1302B. Optionally, the lift arm 504 may be configured to rotate about one or both of the lift arm hubs 1302A, 1302B. In some embodiments, the lift arm 504 may include a lift arm catch 1304, which may be configured to receive the lift arm biasing element 706. It should be appreciated that the lift arm 504 may be formed in any appropriate geometry as the disclosure is not limited sense.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. An exit device comprising:
a latch movable between an extended latch position and a retracted latch position;
a push bar movable between a first push bar position and a second push bar position, wherein movement of the push bar from the first push bar position to the second push bar position moves the latch from the extended latch position to the retracted latch position; and
a lockdown assembly configured to transition between a non-lockdown configuration and a lockdown configuration, wherein in the lockdown configuration the lockdown assembly is configured to maintain the push bar in the first push bar position.

2. The exit device of claim 1, wherein the lockdown assembly is further configured to maintain the latch in the latch extended position.

3. The exit device of claim 1, further comprising a lift arm movably coupled to the push bar and movable between a first lift arm position and a second lift arm position, wherein movement of the push bar from the first push bar position to the second push bar position moves the lift arm from the first lift arm position to the second lift arm position.

4. The exit device of claim 3, wherein the lockdown assembly comprises a lockdown actuator configured to move the lift arm from the first lift arm position to the second lift arm position.

5. The exit device of claim 4, wherein the lockdown actuator is a motor.

6. The exit device of claim 4, wherein the motor is configured to move a connecting member from a first connecting member position to a second connecting member position, and wherein movement of the connecting member from the first connecting member position to the second connecting member position moves the lift arm from the first lift arm position to the second lift arm position.

7. The exit device of claim 5, wherein the lockdown assembly is configured to shut off power to the motor in the lockdown configuration.

8. The exit device of claim 7, further comprising a push bar biasing element configured to bias the push bar to the first push bar position, and wherein in response to power being shut off to the motor, the push bar moves to the first push bar position.

9. The exit device of claim 1, wherein the lockdown assembly includes a rotatable lock cylinder, wherein rotation of the lock cylinder transitions the lockdown assembly between the non-lockdown configuration and the lockdown configuration.

10. The exit device of claim 9, wherein the lockdown assembly includes a cam plate rotatably coupled to the lock cylinder, wherein the cam plate is configured to rotate in conjunction with the lock cylinder to activate a switch, wherein activation of the switch transitions the lockdown assembly between the non-lockdown configuration and the lockdown configuration.

11. The exit device of claim 1, further comprising an indicator configured to indicate a state of the exit device.

12. The exit device of claim 1, wherein the lockdown assembly is configured to be controlled to transition between the non-lockdown configuration and the lockdown configuration remotely.

13. An exit device comprising:
a latch movable between an extended latch position and a retracted latch position;
a push bar movable between a first push bar position and a second push bar position, wherein movement of the push bar from the first push bar position to the second push bar position moves the latch from the extended latch position to the retracted latch position;
a lockdown assembly configured to transition between a non-lockdown configuration and a lockdown configuration, wherein in the lockdown configuration the lockdown assembly is configured to maintain the push bar in the first push bar position; and
an indicator configured to indicate the exit device is in a lockdown configuration in response to the lockdown assembly transitioning to the lockdown configuration.

14. The exit device of claim 13, wherein the indicator comprises an indicator body configured to move between a first indicator body position and a second indicator body position.

15. The exit device of claim 14, further comprising a transmission component movable between a first transmission position and a second transmission position, wherein movement of the transmission component from the first transmission position to the second transmission position moves the indicator body from the first indicator body position to the second indicator body position.

16. The exit device of claim 15, wherein the indicator further comprises an indicator lever configured to move between a first indicator lever position and a second indicator lever position, wherein movement of the indicator lever from the first indicator lever position to the second indicator lever position moves the indicator body from the first indicator body position to the second indicator body position, and wherein movement of the transmission component from the first transmission position to the second transmission position moves the lever arm from the first lever arm position to the second lever arm position.

17. The exit device of claim 15, further comprising a lift arm movable between a first lift arm position and a second lift arm position, wherein movement of the lift arm from the first lift arm position to the second lift arm position moves the transmission component from the first transmission position to the second transmission position.

18. The exit device of claim 13, wherein the indicator further comprises an indicator window, wherein an indication associated with the exit device is visible through the indicator window.

19. The exit device of claim 18, wherein the indicator further comprises a first indicator face and a second indicator face, wherein the indicator is configured to display the first indicator face in response to the lockdown assembly transitioning to a non-lockdown configuration, and wherein the indicator is configured to display the second indicator face in response to the lockdown assembly transitioning to the lockdown configuration.

20. The exit device of claim 19, wherein the first indicator face and the second indicator face are coupled to the indicator body, and wherein the indicator is configured to display the first indicator face when the indicator body is in the first indicator body position, and wherein the indicator is configured to display the second indicator face when the indicator body is in the second indicator body position.

21. The exit device of claim 20, the indicator further comprising an indicator biasing element configured to bias the indicator body in a first direction.

22. The exit device of claim 13, further comprising a push bar biasing element configured to bias the push bar to the first push bar position.

23. The exit device of claim 13, further comprising a motor configured to move the push bar between the first push bar position and the second push bar position, wherein the push bar is configured to move to the first push bar position in response to power being shut off to the motor.

24. The exit device of claim 13, further comprising a rotatable lock cylinder, wherein the lockdown assembly is configured to transition between the non-lockdown configuration and the lockdown configuration in response to rotation of the rotatable lock cylinder.

25. The exit device of claim 17, wherein the transmission component includes a channel configured to engage the lift arm, and wherein movement of the lift arm from the first lift arm position to the second lift arm position rotates the transmission component from the first transmission component position to the second transmission component position via the channel.

26. The exit device of claim 25, wherein the channel is formed as a helical ramp configured to engage the lift arm, and wherein movement of the lift arm from the first lift arm position to the second lift arm position rotates the transmission component from the first transmission component position to the second transmission component position via the helical ramp.

27. The exit device of claim 13, wherein the lockdown assembly is configured to be controlled remotely.
